(19) United States
(12) Patent Application Publication
(10) Pub. No.: US 2010/0052922 A1
(43) Pub. Date: Mar. 4, 2010

(54) REBREATHER OXYGEN RISK ALARM

(76) Inventor: Alexander Roger Deas, Dalkeith (GB)

Correspondence Address: DARBY & DARBY P.C., P.O. BOX 770, Church Street Station, New York, NY, 10008-0770, US

(21) Appl. No.: 12/473,597

(22) Filed: May 28, 2009

Related U.S. Application Data
(60) Provisional application No. 61/056,670, filed on May 28, 2008.

(51) Int. Cl. G08B 17/10; A62B 7/00

(52) U.S. Cl. 340/632; 128/204.22

(57) ABSTRACT

A device that indicates a hypoxia risk or hyperoxia risk, or analogue thereto, using an integral value that is reset when a user activates a switch and which integrates over time from each reset event as a function calculating the PPO2 deviation from parameters that include ambient pressure changes or derivatives thereof and physiological parameters or analogues thereof, from which a metabolic parameter is calculated.

This application claims priority under 35 U.S.C. §119 (e) to U.S. Provisional Patent Application Ser. No. 61/056,670, entitled “REBREATHER OXYGEN RISK ALARM,” and filed May 28, 2008, the contents of which are hereby incorporated by reference as though set forth in its entirety.

### BACKGROUND

Rebreathers are a type of life support equipment that recirculates a user's gas by passing expired gas through a breathing loop comprising counterlungs, a carbon dioxide scrubber and a means to inject oxygen to make up for that lost through metabolism or vented from the loop, then back for the user to inhale.

Though the first rebreather was used in the 18^{th} Century, rebreathers only entered widespread usage in the 1920s for military purposes and the 1990s for sports diving purposes. More than 30 companies offer or have offered rebreathers for sale. There are various different types of rebreather: they can have closed or semi-closed breathing loops; constant mass flow oxygen dosing, pulsed dosing, or demand dosing; manual control or electronic control; and even within manual systems there are those, such as the Jetsam KISS rebreathers, which require frequent attention by the user to inject oxygen, and others, such as the Pelagian rebreather, that can require less frequent attention. There are marked differences in mortality rates between these different types. Semi-Closed Rebreathers (SCRs) tend to have a lower mortality rate than fully closed rebreathers (CCRs). Rebreathers with pulsed manual gas addition (KISS type mCCRs) appear to have a lower risk than rebreathers with electronically controlled gas injection (eCCRs). Rebreathers that demand frequent attention appear to have a lower risk than those that require infrequent attention, from observations of diver mortality per unit.

It is estimated that there have been 14,240 years of diver exposure to May 2009 among seven popular sports eCCRs, compared to 1,545 years of sports mCCR use, during which time there have been 83 fatalities recorded for the eCCRs and none for the mCCRs. The probability of the mCCR having the same or higher risk as the eCCR from this stochastic data is around 8250:1. The mCCRs' apparent safety benefit is despite the fact that many mCCR users have not been trained in their use, whereas almost all eCCR users are trained; the fact that leading mCCRs have serious safety defects, such as a Work Of Breathing several times higher than the recognized safe limit; and use of a single orifice, which is liable to block more frequently than multi-orifice or solenoid designs.

Hypoxia is the most plausible cause of many of these rebreather accidents.

Hypoxia is an insufficiency of oxygen in the breathing gas. Although hypoxia can give rise to some symptoms, including drowsiness, tunneling of vision and light headedness, these symptoms are only pronounced at very low gas pressures, such as the gas pressure experienced by aviators, and these symptoms are not usually experienced by divers. With divers, there are rarely any symptoms of hypoxia: just a sudden loss of consciousness which is normally followed by drowning. The mCCR diver is trained to look frequently at the partial pressure of oxygen (PPO2) monitor to determine the partial pressure of oxygen (PPO2) in his breathing loop, and apply the necessary adjustment, otherwise the diver will certainly die. This imperative is missing in the eCCR, where the equipment maintains the PPO2 automatically-until the equipment fails, whereupon the diver may lose consciousness from hypoxia without realizing a problem exists.

The manufacturers of eCCRs do their best to instruct their users to “Always know your PPO2”, but the equipment does little to ensure that users actually do check their PPO2, other than provide an alarm when the PPO2 is outside safe limits. However, if the equipment controlling PPO2 has failed, then in many cases that alarm fails too.

One of the problems in monitoring PPO2 is that the sensors that detect the level of oxygen in the rebreather are extremely unreliable. The mCCR diver knows what to expect from his PPO2 monitor, so can detect oxygen cell failure. This is not the case with all eCCR users because the equipment maintains the PPO2 automatically, yet there are circumstances where the equipment will try and control the PPO2 in the breathing loop using data from faulty oxygen sensors.

All rebreather divers should check the PPO2 frequently, regardless of the type of rebreather, but the evidence from accident studies is that many do not do so, with fatal results.

### OBJECT

It is an object to ensure a rebreather user checks his PPO2 monitor sufficiently frequently to enable the user to take timely action to maintain the level of oxygen in the breathing loop within safe limits.

It is a further object to provide continuous training to a rebreather user on the frequency the PPO2 needs to be checked, as a function of the rate of ascent or descent.

It is a further object to provide a back-up method for detection and warning of hypoxia risk, which does not rely on a user observing numbers derived from oxygen sensors.

It is a further object to psychologically condition the rebreather user to check the PPO2 monitor frequently.

It is a further object of some embodiments to alert dive buddies or instructors to the extent of unsafe dive practices by a particular diver.

### SUMMARY

Embodiments of the present invention provide a hypoxia risk monitor comprising a PPO2 deviation calculator and a reset switch, which can be activated by a user and which comprises an integrator for integrating over time a function of ambient pressure changes and predefined metabolic parameters.

In an embodiment of the invention, the integrator further integrates a parameter related to oxygen flow rate. In a further embodiment, the hypoxia risk integrator is used to activate an alarm by comparison with either a fixed limit or depth-related limit.

In an embodiment of the invention, a hypoxia risk monitor further comprises a safety indicator display showing a parameter that is a function of the number of times the device has tripped its safety limit.

In an embodiment of the invention, the metabolic parameters are adjusted to the user based on input of the user's weight, height, age and sex. In an embodiment of the invention, the volume in the breathing loop is also adjusted to the user based on input of the user's weight, height, age and sex.

In an embodiment of the invention, a hypoxia risk monitor annunciates a warning when the PPO2 may change as a result of metabolic rate and depth changes, at a smaller PPO2 variation than for a full alarm.

In an embodiment of the invention, the alarm state indicator is preceded by activation of a vibrator in the dive mask, dive helmet or mouthpiece to break the user's attention and thereby enable him to take cognizance of the primary alarm signal.

In an embodiment of the invention, the warning or alarm signals are given by a light or light pattern emitting from a peripheral field display. In an embodiment of the invention, the warning or alarm signals are indicated by an automatic voice annunciation system fitted to the mouthpiece, dive mask or helmet.

In a further embodiment of the invention, a hypoxia risk monitor is integrated with a PPO2 monitor or display such that the switch to reset the interval timer is the same switch that activates the display.

Embodiments of the present invention indicate a hypoxia or hyperoxia risk, by calculation of the likely deviation of PPO2 in a rebreather from the desired set point, over a time interval, as an integral of the effect of ambient pressure changes and metabolism on the loop PPO2, for a specific loop breathing volume. That is, embodiments of the present invention do not use oxygen sensors, though it may be incorporated into an oxygen monitor that does use oxygen sensors. The deviation value is reset, preferably to zero, by the user when the user checks the PPO2 reading. Failure of the user to reset the deviation value before the calculated deviation exceeds safe limits causes an alarm.

To reduce the frequency of false alarms, the preferred embodiments include a means to adjust the metabolic rate used in the calculation of oxygen risk, based on the physiology of the user, particularly weight, height, sex and age, and similarly adjust loop volume using physiological data.

To provide a higher degree of safety, preferred embodiments also include a means to meter the manual or automatic addition of gas to the breathing loop, such as a flow measurement sensor associated with the gas injector.

Embodiments of the present invention may also present data on the safety of the diver to dive buddies or to dive supervisors, by counting the incidence of failures by the diver to observe the PPO2 and displaying that or annunciating that, which may include a weighting of how severe that failure to check the PPO2 could have been, such as a figure derived from the value of the calculated possible deviation immediately prior to the value being reset by the user.

A preferred embodiment of the device can also detect hyperoxia conditions risks using the same method as used to detect a hyperoxia risk by using an upper limit alarm level in addition to the lower limit used to detect hypoxia risk.

### BRIEF DESCRIPTION OF THE FIGURES

Embodiments of the invention will now be described by way of example, without limitation to the generality of the invention, and with reference to the following figures:

FIG. 1 shows a block diagram of a hypoxia monitor according to an embodiment of the present invention, with the additional feature of a gas flow sensor (7), where a high pressure gas cylinder containing oxygen (1) is connected to a pressure regulator (3) that reduces the gas pressure to an intermediate pressure and supplies it to an oxygen dosing device (5) such as a solenoid driven by a rebreather controller in an eCCR or a constant mass flow orifice with a manual oxygen add valve in a mCCR, the output of which is connected to a flow sensor (7), the flow being to the rebreather breathing loop (9). A state machine or programmed device (25) receives data on the ambient depth from a pressure sensor (21) and performs a computation of PPO2 change over a time interval initiated by a user signal switch (11), by combining the pressure data with data on the diver's physiology and the data from the gas flow rate sensor (7). This calculation is described by example in the following description of the operation of the device. The device indicates alarm conditions by an alarm annunciating means (23).

### OPERATION

The operation of embodiments of the invention will be described, without limit to the generality of the invention. For brevity, the examples will assume the user is a diver: it will be apparent from the context how this affects other groups of rebreather users.

An embodiment of the present invention is an alarm device triggered by the “current value” of PPO2 deviation, which is reset to zero by the user signal switch (II), then increases over time by a calculation of PPO2 change by integrating the changes in PPO2 caused by ambient pressure changes and by the user's metabolism.

When there is no oxygen being added by the oxygen dosing device (5), the reduction in PPO2 in a breathing loop is a function of how much gas is added to the breathing loop during descent, the oxygen level in that gas, the volume lost on ascent, the volume of the breathing loop and the metabolic rate of the diver. If these parameters are known, then the PPO2 level in the breathing loop can be calculated.

There are three sets of parameters and calculations to be considered:
1. Choice of appropriate alarm and warning levels
2. Calculation of the change in PPO2 caused by changes in ambient pressure or depth
3. Calculation of the change in PPO2 caused by the user's metabolic consumption.

These will be considered in turn: these three points form the structure of this description of the operation of an embodiment of the present invention.

In determining alarm and warning levels, the following factors are used:
1. The PPO2 in a breathing loop is normally maintained at a desired set point, either manually or electronically. Embodiments of the present invention calculate a deviation from that assumed set point: this assumes the user has the breathing loop at the desired set point when they are observing the PPO2 on a PPO2 monitor or has seen the PPO2 is not within limits and is taking the appropriate corrective action.
2. The PPO2 set point is chosen to optimize overall safety, and deviations in PPO2 from the set point reduce the safety margin, until eventually the deviation is so great that it is a hazard. A common PPO2 set point for divers is 0.7 Atmospheres pressure (ATM) near the surface, increasing to 1.3 ATM at depth, while the limits that sustain life are a PPO2 of between 0.12 ATM and 2.0 ATM—slightly wide limits are tolerated for short periods, and narrower limits are needed if the rebreather is used near these limits for more than a few minutes. An alarm level can be derived from taking the worst case PPO2 set point, and establishing by how much the PPO2 changes before it represents a life critical safety hazard.
3. PPO2 deviations of more than 0.1 ATM from the PPO2 set point change the amount of decompression time required, which itself can be hazardous unless the diver is aware of that change and has planned for it. Therefore an appropriate warning level may be a 0.1 ATM PPO2 change.

Failure to reset the current PPO2 deviation value before the calculated PPO2 deviates by more than a pre-determined safe limit causes a warning or an alarm depending on the magnitude of the calculated deviation. The user signal switch (11) used to reset the deviation value is preferably incorporated into the PPO2 display system, so that to see the display the user signal switch (11) has to be pressed. The operation of the switch (11) means that the user has read the PPO2 display so can be assumed to have taken any corrective action needed to keep the PPO2 at the required set point: either a recognition that the eCCR controller is operating or, in an mCCR, by the user adding oxygen to the breathing loop.

PPO2 is normally controlled to within 0.1 ATM of the set point in a rebreather design, so suitable pre-determined limits for “current value” of PPO2 deviation are, for a warning, a PPO2 0.1 ATM below the PPO2 set point and, for an alarm, 0.5 ATM below the set point. The lower set point that is commonly used, 0.7 ATM, is 0.5 ATM above the point where the rebreather can contain a hypoxic gas, i.e. the 0.7 ATM set point is 0.5 ATM above the PPO2 of air. Therefore by detecting when the PPO2 level in the rebreather may be 0.1 ATM lower than the set point for a warning, and 0.5 ATM lower than the set point for an alarm, an extra layer of safety monitoring can be introduced to the rebreather.

The alarm levels could in some embodiments also take into account the variability of the risk with user and exposure time, to add a third alarm that may trigger an automatic bail out device for example. The level of hypoxia needed for a sudden LOC depends on how fast the PPO2 changes. The Time of Useful Consciousness under hypoxia is described by the Alberta Shock Trauma Air Rescue Society, in the publication “Altitude Physiology”, available on-line from http://www.emergency.ualberta.ca/stars/08%20-%20library/Altitude%20Physiology.doc as of 15 Apr. 2008, and incorporated herein by reference, which contains the following table for time of useful consciousness under hypoxia:

| | | Normal or slow | | | |
|---|---|---|---|---|---|
| Altitude in meters (feet) | | decompression | | Rapid Decompression | |
| 5486 m. | (18,000 ft) or below | 30 | minutes | | |
| 7620 m. | (25,000 ft.) | 3-5 | minutes | 1.5 to 2.5 | minutes |
| 9144 m. | (30,000 ft.) | 90 | seconds | 30-45 | seconds |
| 10,608 m. | (35,000 ft.) | 30-60 | seconds | 15-30 | seconds |
| 12,192 m. | (40,000 ft.)or above | 15 | seconds or less | 7-10 | seconds |

At 30,000 ft, the atmosphere contains around 6% O₂, yet a person undergoing sudden decompression is conscious for 30 to 45 seconds: enough to put on a face mask if the cabin pressure is lost. Where the diver experiences a sudden hypoxia on ascent, this is the general time period involved and the level of the hypoxia.

The calculation of the change in PPO2, i.e., a deviation in PPO2 due to a change in ambient pressure or depth, will now be explained. This calculation requires data on the loop volume and on the ambient pressure. The ambient pressure is measured using a pressure sensor (21).

The volume of a breathing loop is specific to each model of rebreather and is normally determined by the manufacturer. It can also be determined by measurement.

The volume of rigid parts such as the scrubber canister can be measured by filling with water and measuring the weight difference, or emptying the water out and measuring its volume.

The calculation of displacement by the scrubber can be made by measuring the weight of the scrubber fill and dividing it by the relative density (or gas density) of the scrubber material, usually sodalime. The gas density is the amount of gas the sodalime displaces, which is the relative density of the material. While the bulk density of the sodalime used to fill the scrubber may be around 0.9 gms/cm, or 0.9 kg per liter, because it contains gas spaces such that the gas density (i.e. how much gas it displaces) is the density of the material itself, i.e. the relative density, which is much higher than the bulk density. That is, if the sodalime is poured into a container, the weight of the container will increase by 0.9 kg for every liter of space displaced (if the bulk density is 0.9), but the container full of sodalime contains a large portion of space which is occupied by gas. One manufacturer of diver's sodalime, Molecular Products Ltd, states in its datasheet that the relative density of its Sofnolime brand product is 2.0. Note that relative density is a unitless figure as it is a ratio of density to that of water. Because water weighs 1 kg/liter, then the gas density of Sofnolime is calculated to be 2.0 kg/liter. This calculation aids understanding of the following description because it contrasts relative and absolute density figures.

The relative density figure can be checked easily, because the salts that make up the sodalime are stated by the manufacturer, and the density of each of those salts is widely published. Molecular Product's Sofnolime comprises Calcium Hydroxide—Ca(OH)₂ (about 77%), Water—H₂O (about 20%, increasing to over 20% as it is used) and Sodium Hydroxide—NaOH (about 3%). The density of Ca(OH)₂ is 2.2 kg/l, H₂O is of course 1.0, NaOH has an aqueous density of 1.83 kg/l. Therefore the gas density of Sofnolime per kg, calculated from the density of its ingredients, is 1/(0.77*2.24+0.2*1+1.83*.03)=1.98 kg/l. That is, the calculation from the ingredients confirms the figure in the manufacturer's data sheet of 2.01 g/l. A typical rebreather takes a sodalime fill weighing 2.5 kg, and as it has a gas density of 2.0, the solid salts that compose the lime will displace 1.25 liters of gas. Draeger Divesorb has an almost identical composition and gas displacement.

As an example, breathing loop measurements taken on one of the most popular rebreathers, a Buddy Inspiration, are:

| Component | Dead space (liters) |
|---|---|
| Scrubber canister | 4.25 |
| T pieces to counterlungs | 0.22 |
| Hoses: four hoses each, 32 mm internal | 1.33 |
| bore and 46 to 48 cm long. | |
| Mouthpiece | 0.11 |
| Counterlung dead space fully | 0.2 |
| collapsed, for both counterlungs | |
| Total with no sodalime | 6.11 |
| Of which a 2.5 kg sodalime fill in the | −1.25 |
| scrubber canister will take: | |
| Total dead space is | 4.86 |

The rebreather dead space is a fixed figure that does not change. A value for the rebreather dead space can be pre-set into the hypoxia monitoring device.

In addition to the dead space in the rebreather, the breathing loop also contains the gas in the user's lungs, some of which will oscillate backwards and forward with the counterlungs, and in some parts of the dive, the counterlungs will collapse or fill. The volume of gas in the lungs and counterlungs can either be modeled by taking an average diver, or calculated using the parameters entered by the user that enable his/her metabolism to be estimated: weight, height, age and sex.

The counterlungs in the rebreather example given above accommodate 3.95 liters of gas when full, which is less than the free volume of the counterlungs due to the restriction on their expansion from the harness. Of the 3.95 liters, 0.2 is accounted as dead space, so the variable volume is 3.75 liters. The amount of that which is used varies during the dive.

When leaving the surface, a rebreather diver has only a small residual volume in his lungs, because to reduce his buoyancy sufficiently to leave the surface, he normally has to maximally exhale. In doing so, the diver empties the counterlungs. Once below the surface, the diver then fills his lungs further with a functional reserve volume to achieve a comfort level; as he breathes, the tidal volume of air in his lungs is additional to this functional reserve. During his ascent, the gas in the counterlungs expands, and the diver has to continually vent the rebreather to remain comfortable. There are thus three phases of the dive, for which the volume needs to be determined:

Just leaving the surface, where the loop volume is the dead space of the rebreather plus the residual volume (RV) in the diver's lungs.

Comfort level during statis depth phases of the dive, where the loop volume is the dead space plus the diver's end of normal expired breath volume (EEPV) and the tidal volume (TV) of his lungs.

During active ascent, the loop volume is the dead space plus the diver's end of normal expired breath (EEPV) plus the volume of full counterlungs.

In Phase 1 above, where the diver is leaving the surface, the Residual Volume (RV) can be calculated from parameters entered by the user. See: Crapo RO, Morris AH, Clayton PD, and Nixon CR, in “Lung Volumes in Healthy Nonsmoking Adults,” Bull. Europ. Physiopathol. Respir. 1982; 18:419-425, incorporated herein by reference, provide an equation for Residual Volume as:

RV=0.0495* Height (inches)+0.0246* Age (years)−2.6830[Men]

A similar equation is given for women. A typical 70 kg male has a Residual Volume of around 1.2 liters, but a large male may have a volume of 2.1 liters or more. The difference between a small woman and a very large man can be 3:1. It is for this reason that the preferred embodiment prompts the diver to specify his/her height, age and sex in a user menu on setup.

In Phase 2 above, the dead volume is added to the Expired End of normal Breath Volume and the Tidal Volume. Fortunately, a lot of research has been done on the total lung capacity at end of expired breath during normal exercise. A good example of this is the paper by J. Babb and J. Rodart, “Lung Volumes during low intensity steady-state cycling”, Journal of Applied Physiology, 1991, V70-2, p934, incorporated herein by reference.

The researchers in the above paper measured Expired End of Breath Volume (EEBV) for candidates who were doing gentle cycling: this is similar to the exercise carried out by a diver. The Expired End of Breath Volume (EEBV) under light exercise was around 47% of the Total Lung Capacity (TLC). The TLC can be estimated by determining the Vital Capacity (VC) and adding the RV. The VC for an average 70 kg male diver has been measured in Royal Navy trials to be around 4.5 liters, increasing and decreasing with the size and weight of the diver. A rough approximation is that for every 30 kg by which the diver exceeds 70 kg, the VC increases by 1 liter. Various other calculations are available for females and which relate to height as well as weight. Forty-seven percent is a reasonable estimate of the diver's EEBV when the TLC is calculated as the sum of the calculated VC and RV.

The tidal volume of a diver's breathing depends on metabolic demand. This varies during the dive. During the initial few minutes of the dive, the demand appears to be higher than near the end of the dive. A typical figure of 1 liter can be used: a higher figure will be more than offset by the higher metabolic demand that is associated with that higher volume.

In Phase 3 of the dive, a pair of fully expanded counterlungs typically holds 4 liters when constrained by harness and rebreather housing, of which 0.2 has already been accounted for as dead space. This counterlung capacity does vary from model to model of rebreather, but is another fixed value that can be determined by the manufacturer. Active ascent is where the ascent rate is more than the diver can easily vent to keep the counterlungs at their minimum, for example, 30 n/min. It is safer to allocate a high figure for the ascent rate to keep counterlungs filled than a low figure such as 10 m/min, because when the counterlungs are full during ascent there is more oxygen available to metabolize than when the counterlungs are emptied at the end of each breath.

Taking the average 70 kg male as an example, the volumes in each part of the dive would be:

Phase 1: Initial two meters descent, 4.86 liters rebreather dead space plus 1.2 liters RV=6.06 liters

Phase 2: Comfort level static depth portions of the dive: 4.86 liters rebreather dead space plus diver's EEBV of 2.68 liters plus Tidal Volume of 1 liter=8.54 liters.

Phase 3: Active ascent: 4.86 liters rebreather dead space plus 4 liters in full counterlungs minus 0.2 accounted as dead space, plus the diver's EEBV of 2.68 liters=11.34 liters.

The next item that has to be modeled is the effect of gas additions and losses to the breathing loop. Additions occur during descent, where the diluent gas is added to maintain loop volume. If the fraction of diluent gas is known by being declared in a menu by the user, and the pressure increase is known, then the amount of diluent gas added is the breathing loop volume, as calculated above, multiplied by the change in absolute pressure.

Likewise during ascent, gas is lost from the loop in direct proportion to the change in absolute pressure. For example, a change from a depth of 10 msw to the surface results in a pressure change of approximately 2 bar absolute to 1 bar absolute, so the quantity of gas in the breathing loop will be halved, and the PPO2 in the breathing loop will also halve unless oxygen is dosed. These changes in PPO2 are purely the result of the change in ambient pressure: the metabolism of oxygen by the diver will reduce the PPO2 further.

The description of the operation will now move on to consider the effect of the user's metabolism on the loop PPO2 deviation.

The reduction in PPO2 caused by metabolism is simply the volume of gas in the loop, multiplied by the metabolic consumption in liters per minute. For example, a 10 liter breathing loop with a diver metabolizing 1 liter per minute will reduce the PPO2 by 0.1 if the depth is constant and no oxygen is being dosed.

The effect of the change in loop PPO2 caused by metabolism is additive to the effect caused by changes in ambient pressure. For example, if the increase in depth causes an increase in loop PPO2 by 0.2 and the metabolic consumption in that same time period causes a reduction in PPO2 by 0.05, then the net effect is a change in loop PPO2 of 0.15.

Preferred embodiments tune the calculation of metabolic rate change by prompting the user in a set up menu to declare the fraction of oxygen in the diluent gas and physiological information that is useful in calculating his/her metabolism, particularly weight, height, age and sex. An embodiment can also prompt the user for information on whether there is a current running, so the workload involved can be adjusted.

A example method of how metabolism can be calculated from either simple parameters entered by the user, or preset parameters will now be described.

There are various formulae published that relate metabolism to body surface area, which can be estimated using a subject's weight, height and sex. For example, the basal metabolism formula by MD Mifflin, S T St Jeor, L A Hill, B J Scott, S A Daugherty and Y O Koh, “A new predictive equation for resting energy expenditure in healthy individuals,” published in the American Journal of Clinical Nutrition, Vol 51, 241-247 and online from http://www.ajcn.org/cgi/content/abstract/51/2/241 as of 15th Apr. 2008, incorporated herein by reference, is:

Basal metabolism (calories/day)=10* weight in kg+6.25* height in cm−5* age+5, for males.

There is a similar formula published for females by the same authors.

On top of the basal metabolism is the effort to move the body to carry out an activity. For example, for each major sport, there is a formula for the extra energy needed, such as the widely published Balke VO2 test. The figure for male football is 62 ml/kg/min, meaning that for every kg of weight, an average male needs 62 ml of oxygen in addition to his basal metabolic rate.

A user's metabolism can be modeled as the basal metabolism plus a figure per kilo of weight to reflect the activity level involved. For diving, base metabolism plus 55 ml of oxygen per kilo is a useable metabolic rate for the purposes of embodiment of the present invention.

The use of the breathing loop volume calculated as described herein, with the metabolic rate calculated herein, provides a workable estimate of PPO2 change in a breathing loop for the purposes of a warning and alarm device, if the limits are set reasonably close to the PPO2 set point; for example, a 0.1 ATM drop for a warning and a 0.52 ATM drop for an alarm. Much more detailed models exist using the diver's dive profile, published on www.deeplife.co.uk/or.php under the Verification section: these were developed by the present inventor and his colleague for purposes that include reconstructing the PPO2 given a known subject and dive profile. Those models in Matlab are suitable for use with embodiments of the present invention, with the obvious adaptations.

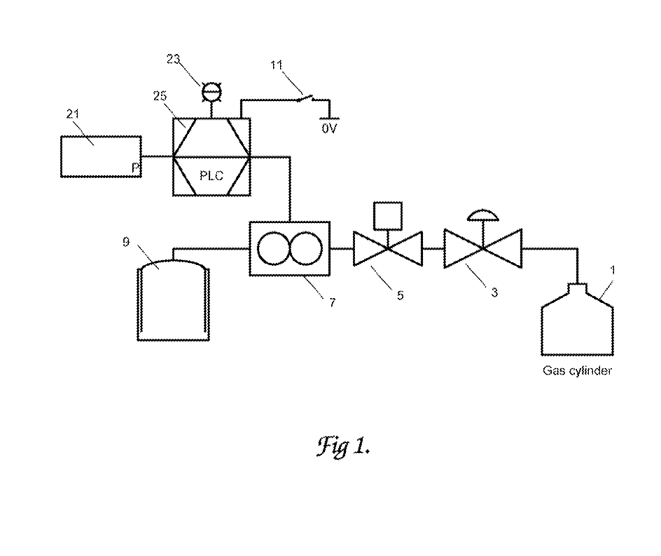

In FIG. 1, the programmed device (such as a microcontroller or PLC or state machine) (25) that implements the calculations described, or analogues thereto, should, in a preferred embodiment, be isolated from the device that measures and displays the PPO2, except for the reset switch (11), which can be shared between the two subsystems by lining the subsystems using current-limiting resistors to the switch: the switch (11) as drawn in FIG. 1 requires a pull-up resistor in the programmed device (25), and for ease of interconnecting these two systems in a reliable manner, the pull-up may also be shared between the two systems: alarm and PPO2 indicator.

The PPO2 measurement and indicator systems are normally redundant due to the poor reliability of oxygen sensors, permitting achievement of the required system MTBCF (mean time between critical failure).

The alarm annunciating means (23) may be a high brightness LED placed directly in front of the diver, augmented by an audio alarm. In a preferred embodiment, a vibrating device in the mouthpiece or dive mask is triggered, prior to an alarm state, to cause the user to break out of any state of mind where his attention may be on another matter: in effect, it is an attention-defocusing device. The vibrator in the mask can be placed beside the temple area of the diver's head, and comprise a DC motor with an off-balance weight, rotating at 600 rpm. A short burst of half a second from the motor, followed immediately by the alarm signal, is more effective than either just the alarm LED on its own, or using the vibrator as an alarm annunciator. It is possible to provide a two-level alarm, the first level without the attention-defocusing action and the second level with the action, if there has been no response to the first level; this would further heighten the unusual nature of the defocusing action. The action of the defocusing device is then similar to a touch on the shoulder for someone who is focused on another activity: it causes him to snap out of that activity and be in a state where he is more likely to take notice of other input.

Another variation of the alarm annunciating means (23) is to provide voice annunciation by placing a speaker in the mouthpiece, combining the alarm function with that of a Peripheral Field Display that is commonly attached to the mouthpiece of a rebreather.

A preferred embodiment also includes a flow sensor to reduce the reduction in loop PPO2 deviation from metabolism when there is gas flowing from the oxygen dosing device (5) in the breathing loop, to reduce the incidence of false alarms. For example, in a mCCR the flow orifice normally supplies around 0.7 liters per minute of oxygen, so when the flow sensor signal is present the metabolic rate can be reduced by 0.7 liters per minute to give the net amount of PPO2 in the loop that is metabolized. However, it is not desirable to stop the timer completely when gas is flowing, as there is strong statistical evidence that where users check the PPO2 display frequently there are fewer accidents than on equipment that allows the diver to ignore the PPO2 display for long periods, and the flow will not match metabolic consumption perfectly.

A preferred embodiment also includes a flow sensor to account for oxygen added to the loop when there is gas flowing from the oxygen dosing device (5) in the breathing loop, to reduce the incidence of false alarms. For example, in a MCCR the flow orifice normally supplies around 0.7 liters per minute of oxygen, so when the flow sensor signal is present 0.7 liters per minute of oxygen is added. In this example, a diver metabolizing 1 liter per minute would have 0.7 liters provided by the oxygen flow so the amount in the loop that is metabolized is only 0.3 liters per minute, so long as the oxygen flow sensor indicates that gas is flowing. However, it is not desirable to stop the timer completely when gas is flowing even in an eCCR, as there is strong statistical evidence that where users check the PPO2 display frequently there are fewer accidents than on equipment that allows the diver to ignore the PPO2 display for long periods.

The flow sensor (7) can augment the metabolic calculation by indicating when a minimum flow of oxygen is occurring. A typical oxygen bleed figure into the loop is 0.7 to 2 liters per minute STPB (Standard Temperature, Pressure and Dry). This is a very low flow rate and a conventional flow meter is likely to show a large degree of error in handling such a small flow rate with a wide range of ambient pressures. For example, if the intermediate pressure is 10 bar above ambient and the rebreather is at less than 50 msw, the size of the orifice for 0.7 liters per minute is around 80 microns. With such fine tolerances, normal flow sensors tend to be unreliable. A solution to this problem is to use the energy in the gas from the oxygen dosing device (5) to move a sprung paddle, in a similar way to that in which a person may blow a tissue: the impact of gas onto the tissue or paddle causes a movement which can be detected readily. When the gas flow stops or falls below a critical level, this can be detected and either an alarm can be raised or the interval counter used to time the reduction in PPO2 can be allowed to increment at an accelerated rate.

Whilst hypoxia is the predominant risk in rebreathers, a risk of hyperoxia (too high a PPO2) also exists, especially during some phases of the dive, such as descent. The oxygen risk monitor can prompt the user to present the fraction of oxygen in the diluent gas and use the descent rate to determine the amount of injected gas, and calculate whether a hyperoxia risk is present.

For reasons of clarity, the electrical power systems needed to switch on and power the oxygen risk monitor are not shown in FIG. 1. The power systems for a safety device are normally of a redundant design (dual redundancy is usually sufficient): note that redundancy here is used in the technical safety engineering sense—it does not mean “not required” but that multiple instances of the power system are demanded, but some embodiments of poor design may use only one power system.

In a preferred embodiment the oxygen risk monitor switches itself on when either the user presses the user switch (11) or water is detected using wet contacts. The programmed device (25) should also have an effective power brown out reset circuit, and a watchdog timer to ensure safe operation at all times.

A safety indicator, can be provided to show the number of times the alarm limits are tripped, and preferably also the maximum calculated PPO2 deviation prior to the user applying the reset. The safety indicator can take the form of a seven segment LED, or an OLED or other display, or may be integrated into an associated dive computer display and may be combined with an audible warning to alert a dive buddy or supervisor to an unsafe diving practice.

1. An oxygen risk monitor, comprising
a PPO2 deviation calculator to calculate deviation of a PPO2 value from a PPO2 set point, for gas passing through a breathing loop; and
a reset switch, which is user activatable and which comprises an integrator to integrate over time a function of ambient pressure changes and predefined metabolic parameters.

2. The oxygen risk monitor according to claim 1 where the integrator further integrates a parameter related to oxygen flow rate.

3. The oxygen risk monitor according to claim 1 where the integrator is used to activate an alarm by comparison with at least one of a fixed limit and a depth-related limit.

4. The oxygen risk monitor according to claim 1 further comprising a safety limit and a safety indicator display showing a parameter that is a function of a number of times the oxygen risk monitor has tripped its safety limit.

5. The oxygen risk monitor according to claim 1 wherein the metabolic parameters are adjusted to a user based on input of the user's weight, height, age and sex.

6. The oxygen risk monitor according to claim 1 wherein a volume in a breathing loop is adjusted for the user based on input of the user's weight, height, age and sex.

7. The oxygen risk monitor according to claim 1 which annunciates a warning, by use of one or more warning signals, when the PPO2 value may change as a result of metabolic rate and depth changes, at a smaller PPO2 variation than for a full alarm.

8. The oxygen risk monitor according to claim 3 wherein the alarm is preceded by activation of a vibrator in one of a dive mask, a dive helmet and a mouthpiece, to break the user's attention so that the user notices the primary alarm signal.

9. The oxygen risk monitor according to claim 7 wherein the warning signals are given by one of a light and a light pattern emitting from a peripheral field display.

10. The oxygen risk monitor according to claim 7 where the warning signals comprise an automatic voice annunciation system fitted to one of the mouthpiece, the dive mask and the helmet.

11. The oxygen risk monitor according to claim 1 that is integrated with a PPO2 monitor or display such that the switch to reset the interval timer is the same switch that activates the display.

12. The oxygen risk monitor according to claim 1, further comprising a flow measurement sensor to measure an addition of gas to the breathing loop.

13. The oxygen risk monitor of claim 1, wherein the oxygen risk monitor is configured to monitor at least one of a hypoxia condition and a hyperoxia condition.

14. The oxygen risk monitor according to claim 1 wherein the metabolic parameters are adjusted to a user based on input of current flow conditions experienced by a user.

15. The oxygen risk monitor according to claim 1, further comprising a programmed device configured to adjust the metabolic parameters, wherein the programmed device is isolated from the circuit that measures and displays the PPO2, except for a shared reset switch.

16. The oxygen risk monitor according to claim 1, further comprising a programmed device configured to adjust the metabolic parameters, wherein the programmed device is isolated from the circuit that measures and displays the PPO2, except for a shared reset switch.

17. The oxygen risk monitor according to claim 1, further comprising a flow sensor to reduce a reduction in loop PPO2 deviation from metabolism when there is gas flowing in the breathing loop from an oxygen dosing device.

18. The oxygen risk monitor according to claim 1, further comprising a flow sensor to account for oxygen added to the loop when gas is flowing in the breathing loop from an oxygen dosing device.

19. The oxygen risk monitor according to claim 1, wherein the oxygen risk monitor switches itself on when water is detected using wet contacts.

20. The oxygen risk monitor according to claim 1, wherein the oxygen risk monitor is configured to count a number of failures by the user to observe a warning or an alarm.
